(19) United States
(12) Patent Application Publication
(10) Pub. No.: US 2026/0110909 A1
(43) Pub. Date: Apr. 23, 2026

(54) DIFFRACTION GRATING, OPTICAL WAVEGUIDE APPARATUS, AND DISPLAY DEVICE

(71) Applicant: META-BOUNDS INC., Zhuhai (CN)

(72) Inventors: Chendi Shao, Zhuhai (CN); Song Xu, Zhuhai (CN); Jian Guan, Zhuhai (CN); Xing Zhou, Zhuhai (CN)

(21) Appl. No.: 19/380,306

(22) Filed: Nov. 5, 2025

Related U.S. Application Data
(63) Continuation of application No. PCT/CN2024/081929, filed on Mar. 15, 2024.

(30) Foreign Application Priority Data
May 8, 2023 (CN) 202310509381.5

(51) Int. Cl. G02B 27/01; G02B 5/18

(52) U.S. Cl. CPC G02B 27/0172; G02B 5/1842; G02B 2027/0174

(57) ABSTRACT

An diffraction grating comprises: a substrate; and a plurality of micro-structure units, which are formed on the substrate and are periodically arranged at intervals in a first dimension direction (p₁) and a second dimension direction (p₂). A pattern formed by the orthographic projections of the micro-structure units on the substrate comprises a first closed pattern, wherein the first closed pattern is an asymmetric pattern, the boundary of the first closed pattern is formed by sequentially connecting three or more edges in a surrounding manner, and among the three or more edges, there is at least one straight-line edge, which is neither parallel to the first dimension direction (p₁) nor to the second dimension direction (p₂).

### CROSS-REFERENCE TO RELATED APPLICATIONS

This application is a continuation of International Patent Application NO. PCT/CN2024/081929, filed on Mar. 15, 2024, which is based upon and claims priority to Chinese Patent Application No. 202310509381.5, filed before China National Intellectual Property Administration on May 8, 2023 and entitled “DIFFRACTION GRATING, OPTICAL WAVEGUIDE APPARATUS, AND DISPLAY DEVICE”, the entire contents of which are incorporated herein by reference.

### TECHNICAL FIELD

The present disclosure belongs to the technical field of optical display, and particularly relates to a diffraction grating, an optical waveguide apparatus and a display device.

### BACKGROUND

In the fields of Augmented reality (AR) and Mixed reality (MR), as compared to display solutions such as Bird Bath (BB, a semi-reflective and semi-transmissive mode), fly-eye (an off-axis reflective mode) and free-form prism, the optical waveguide solution is thinner and lighter with a larger eye box, and thus has broader prospects for disclosure.

In the optical waveguide solution, as compared to the array-type optical waveguide adopting partial transmissive/reflective films, the diffractive optical waveguide is less difficult to produce and prepare and eliminates grid-like dark stripe when implementing two-dimensional pupil expansion, and thus the diffractive optical waveguide has gained more attention. At present, the diffractive optical waveguide mainly includes optical waveguide schemes based on one-dimensional grating and optical waveguide schemes based on two-dimensional grating. As compared to the optical waveguide design scheme based solely on one-dimensional grating, the optical waveguide design scheme based on two-dimensional grating can realize two-dimensional pupil expansion without a turning area, so it can provide a larger eye box and has greater advantages.

### SUMMARY

The present disclosure adopts the following technical schemes.

A diffraction grating is provided, which includes:
a substrate;
a plurality of micro-structure units formed on the substrate and periodically arranged at intervals in a first dimension direction and a second dimension direction, a pattern formed by the orthographic projections of the micro-structure units on the substrate includes a first closed pattern; in which the first closed pattern is an asymmetric pattern, the boundary of the first closed pattern is formed by sequentially connecting three or more edges in a surrounding manner, and among the three or more edges, there is at least one straight-line edge, which is neither parallel to the first dimension direction nor to the second dimension direction.

The present disclosure further provides an optical waveguide apparatus, which includes:
a base;
the base being provided with at least one of a coupling-in grating, a coupling-out grating and an intermediate grating; in which
at least one of the coupling-in grating, the coupling-out grating and the intermediate grating adopts the diffraction grating described above in some areas.

Further speaking, the present disclosure further provides a display device, which includes the optical waveguide apparatus described above.

### BRIEF DESCRIPTION OF THE DRAWINGS

FIG. 1 is a schematic structural view of a diffraction grating according to one or more embodiments.

FIG. 2A to FIG. 2G show the boundary shape of a micro-structure unit according to one or more embodiments.

FIG. 3A to FIG. 3H show adjustable parameters of a micro-structure unit according to one or more embodiments.

FIG. 4A and FIG. 4B show chamfer diagrams of a micro-structure unit according to one or more embodiments.

FIG. 5 shows the boundary shape of a micro-structure unit according to one or more embodiments.

FIG. 6A to FIG. 6F show schematic cross-sectional structures of a diffraction grating according to one or more embodiments.

### DETAILED DESCRIPTION

In order to make the objectives, technical solutions and advantages of the present disclosure more clear, specific embodiments of the present disclosure will be detailed hereinafter with reference to the attached drawings. Examples of these preferred embodiments are illustrated in the accompanying drawings. The embodiments of the present disclosure shown in the attached drawings and described according to the attached drawings are merely exemplary, and the present disclosure is not limited to these embodiments.

Unless otherwise defined, all technical and scientific terms used herein have the same meaning as commonly understood by those skilled in the art of the present disclosure. The terms used in the specification of the present disclosure are for the purpose of describing specific embodiments and are not intended to limit the present disclosure.

It shall be noted that, when a component is said to be “disposed on” another component, it may be directly or indirectly disposed on the other component.

It shall be additionally noted that, the same or similar reference numerals in the attached drawings of the embodiments of the present disclosure correspond to the same or similar parts. In the description of the present disclosure, it shall be appreciated that, orientation or positional relationships indicated by terms such as “upper”, “lower”, “left” and “right” are orientation or positional relationships shown based on the attached drawings, and they are used for the convenience of describing the present disclosure and simplifying the description, instead of indicating or implying that the devices or elements referred to must have a specific orientation and must be constructed and operated in a specific orientation. Therefore, the terms describing the positional relationships in the attached drawings are used for illustrative description, and should not be construed as limitations to this patent. Specific meanings of the above terms can be understood by those of ordinary skill in the art based on specific circumstances.

Here, it shall be additionally noted that, in order to avoid obscuring the present disclosure with unnecessary details, the structures and/or processing steps closely related to the scheme according to the present disclosure are shown in the attached drawings, and other details that are less related to the present disclosure are omitted.

In the existing optical waveguide based on two-dimensional grating, a two-dimensional diffraction grating is usually composed of a plurality of micro-structure units periodically arranged along the two dimension directions, and the micro-structure units are columnar structures with cross sections in regular shapes such as circles, ellipses, triangles and parallelograms.

In the process of implementing embodiments of the present disclosure, the inventors have found that the two-dimensional diffraction grating in the above related technology has at least the following problems: the micro-structure units have less shape adjustable parameters and low degree of freedom for design, which is not conducive to the adjustment of coupling-out efficiency.

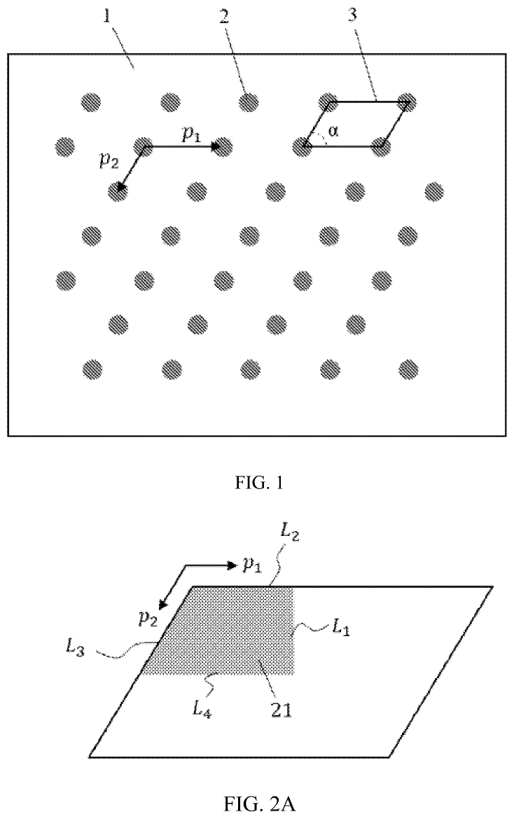

An embodiment of the present disclosure first provides a diffraction grating. As shown in FIG. 1, the diffraction grating 10 includes a substrate 1 and a plurality of micro-structure units 2 formed on the substrate 1 and periodically arranged in a first dimension direction p₁ and a second dimension direction p₂. The micro-structure units 2 have an arrangement period |p₁| in the first dimension direction p₁, and the micro-structure units 2 have an arrangement period |p₂| in the second dimension direction p₂. It shall be noted that, the micro-structure units 2 are shown as dots in FIG. 1 to illustrate the array arrangement structure of the micro-structure units 2 on the substrate 1, and it does not mean that the micro-structure units 2 are circular in shape.

In one or more embodiments, referring to FIG. 1, in the first dimension direction p₁ and the second dimension direction p₂ in which the micro-structure units 2 are periodically arranged at intervals, in a parallelogram 3 formed by taking two arrangement periods as two groups of opposite sides, the angle of the relatively smaller inner angle α is 30° to 85°. This parallelogram 3 is a repeating unit with the smallest area and the smallest edge length, so it is defined as a grating unit, and the angle of the relatively smaller inner angle in the repeating grating units is 30° to 85°.

In one or more embodiments, referring to FIG. 1, the arrangement period |p₁| in the first dimension direction p₁ of the micro-structure unit 2 may be set to 150 nm to 2 μm; and the arrangement period |p₂| in the second dimension direction p₂ of the micro-structure unit 2 may be set to 150 nm to 2 μm. In a more preferred scheme, the arrangement period |p₁| in the first dimension direction p₁ of the micro-structure unit 2 is not equal to the arrangement period |p₂| in the second dimension direction p₂, that is, |p₁|≠|p₂|.

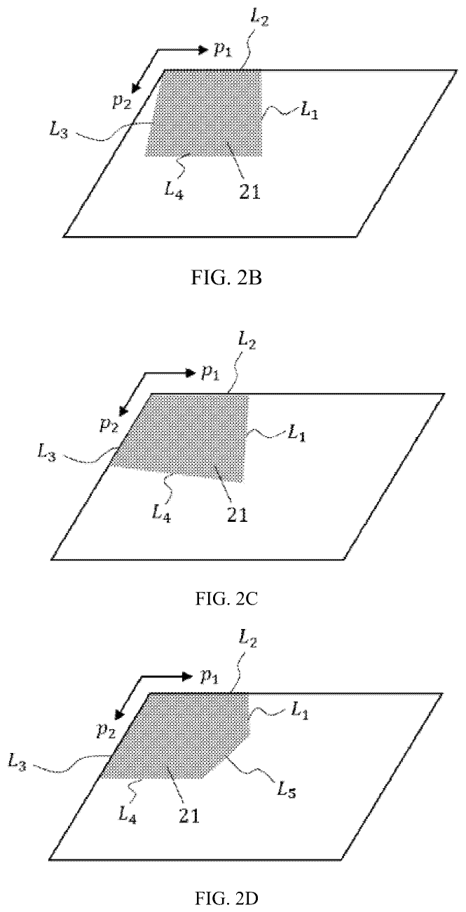

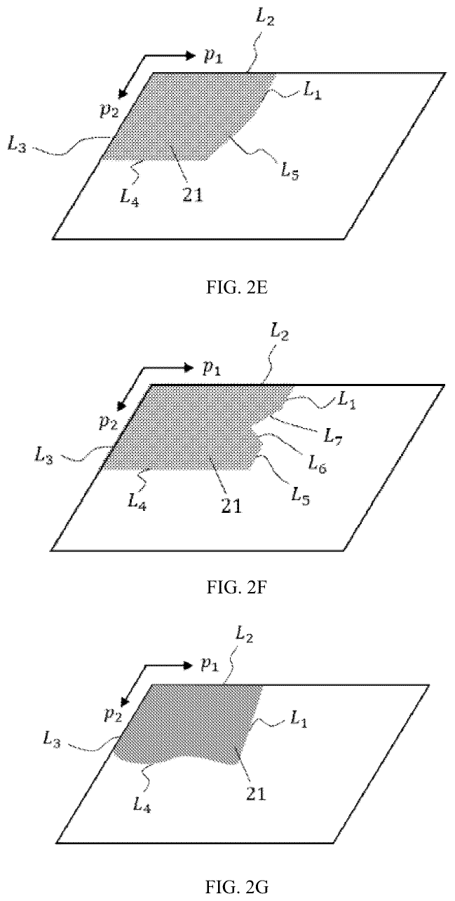

In the diffraction grating provided according to the embodiment of the present disclosure, a pattern formed by the orthographic projection of the micro-structure unit 2 on the substrate 1 includes a first closed pattern. FIG. 2A to FIG. 2G respectively show the structural shapes of the micro-structure units 2 in some specific embodiments of the present disclosure. As shown in FIG. 2A to FIG. 2G, the pattern formed by the orthographic projection of the micro-structure unit 2 on the substrate 1 includes a first closed pattern 21, which is an asymmetric pattern, and the boundary of the first closed pattern 21 is formed by sequentially connecting three or more edges in a surrounding manner, and among the three or more edges, there is at least one straight-line edge which is neither parallel to the first dimension direction p₁ nor to the second dimension direction p₂.

Hereinafter, the micro-structure units 2 shown in FIG. 2A to FIG. 2G are taken as examples for specific description.

For example, for the structural shape of the micro-structure unit 2 shown in FIG. 2A, the boundary of the first closed pattern 21 is formed by sequentially connecting four edges L₁, L₂, L₃ and L₄ in a surrounding manner, and the four edges L₁, L₂, L₃ and L₄ include: straight-line edges L₂ and L₄ parallel to the first dimension direction p₁, a straight-line edge L₃ parallel to the second dimension direction p₂, and at least one straight-line edge L₁ that is neither parallel to the first dimension direction p₁ nor to the second dimension direction p₂.

For example, for the structural shape of the micro-structure unit 2 shown in FIG. 2B, the boundary of the first closed pattern 21 is formed by sequentially connecting four edges L₁, L₂, L₃ and L₄ in a surrounding manner, and the four edges L₁, L₂, L₃ and L₄ include: straight-line edges L₂ and L₄ parallel to the first dimension direction p₁, and two straight-line edges L₁ and L₃ that are neither parallel to the first dimension direction p₁ nor to the second dimension direction p₂.

For example, for the structural shape of the micro-structure unit 2 shown in FIG. 2C, the boundary of the first closed pattern 21 is formed by sequentially connecting four edges L₁, L₂, L₃ and L₄ in a surrounding manner, and the four edges L₁, L₂, L₃ and L₄ include: a straight-line edge L₂ parallel to the first dimension direction p₁, a straight-line edge L₃ parallel to the second dimension direction p₂, and two straight-line edges L₁ and L₄ that are neither parallel to the first dimension direction p₁ nor to the second dimension direction p₂.

For example, for the structural shape of the micro-structure unit 2 shown in FIG. 2D, the boundary of the first closed pattern 21 is formed by sequentially connecting five edges L₁, L₂, L₃, L₄ and L₅ in a surrounding manner, and the five edges L₁, L₂, L₃, L₄ and L₅ include: straight-line edges L₂ and L₄ parallel to the first dimension direction p₁, a straight-line edge L₃ parallel to the second dimension direction p₂, and two straight-line edges L₁ and L₅ that are neither parallel to the first dimension direction p₁ nor to the second dimension direction p₂.

For example, for the structural shape of the micro-structure unit 2 shown in FIG. 2E, the boundary of the first closed pattern 21 is formed by sequentially connecting five edges L₁, L₂, L₃, L₄ and L₅ in a surrounding manner, and the five edges L₁, L₂, L₃, L₄ and L₅ include: straight-line edges L₂ and L₄ parallel to the first dimension direction p₁, straight-line edges L₁ and L₃ parallel to the second dimension direction p₂, and a straight-line edge L₅ that is neither parallel to the first dimension direction p₁ nor to the second dimension direction p₂.

For example, for the structural shape of the micro-structure unit 2 shown in FIG. 2F, the boundary of the first closed pattern 21 is formed by sequentially connecting seven edges L₁, L₂, L₃, L₄, L₅, L₆ and L₇ in a surrounding manner, and the seven edges L₁, L₂, L₃, L₄, L₅, L₆ and L₇ include: straight-line edges L₂ and L₄ parallel to the first dimension direction p₁, straight-line edges L₁, L₃ and L₅ parallel to the second dimension direction p₂, and two straight-line edges L₆ and L₇ that are neither parallel to the first dimension direction p₁ nor to the second dimension direction p₂.

For example, for the structural shape of the micro-structure unit 2 shown in FIG. 2G, the boundary of the first closed pattern 21 is formed by sequentially connecting four edges L₁, L₂, L₃ and L₄ in a surrounding manner, and the four edges L₁, L₂, L₃ and L₄ include: a straight-line edge L₂ parallel to the first dimension direction p₁, a straight-line edge L₃ parallel to the second dimension direction p₂, and a straight-line edge L₁ and a curved-line edge L₄ that are neither parallel to the first dimension direction p₁ nor to the second dimension direction p₂. As a preferred scheme, as shown in FIG. 2G, the curved-line edge L₄ is a wavy curved-line edge with at least one peak and at least one valley, so that the uniformity of pupil expansion in different directions of the diffraction grating can be effectively improved.

In the diffraction grating as described in the above embodiment, the micro-structure unit of the two-dimensional diffraction grating is an asymmetric structure, and among the edges constituting the boundary of the micro-structure unit of the two-dimensional diffraction grating, there is at least one straight-line edge which is not parallel to either of the two dimension directions periodically arranged. Consequently, the micro-structure unit has more adjustable parameters and rich degree of freedom for design, therefore facilitating the adjustment of coupling-out efficiency, and improving diffraction selectivity, diffraction efficiency and brightness of images watched by human eyes.

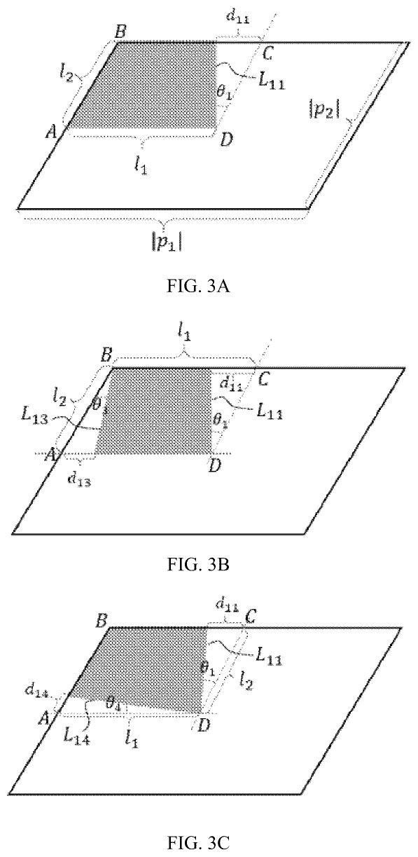

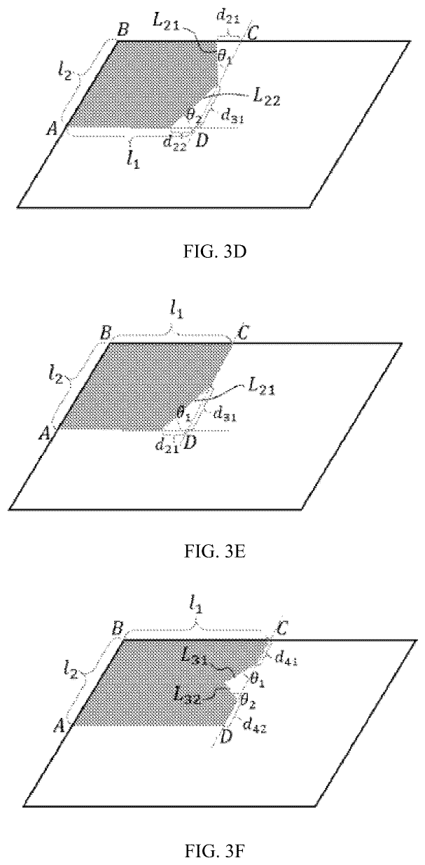

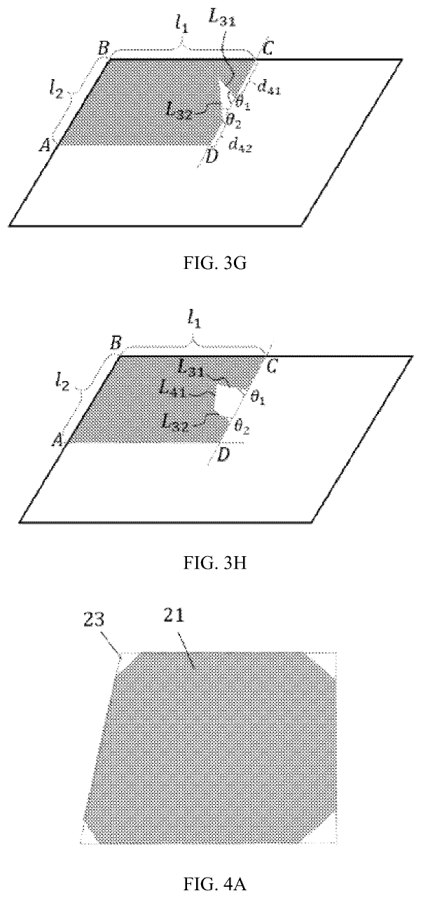

In one or more embodiments, referring to FIG. 3A to FIG. 3H, the straight-line edge neither parallel to the first dimension direction p₁ nor to the second dimension direction p₂ is a transformation edge, and an included angle formed by the intersection of the transformation edge with the first dimension direction p₁ or the second dimension direction p₂ and located outside the first closed pattern 21 is a transformation angle ϑᵢ, i=1, 2, 3, 4, . . . , i.e., i is a positive integer. The transformation angle ϑᵢ preferably ranges from 5° to 175°. For example, in the structures shown in FIG. 3A to FIG. 3F and FIG. 3H, the transformation angles ϑᵢ are all acute angles. In the structure shown in FIG. 3G, one of the transformation angles ϑᵢ (the transformation angle ϑ₂ in FIG. 3G) is an acute angle and the other transformation angle ϑᵢ (the transformation angle ϑ₁ in FIG. 3G) is an obtuse angle. By adjusting the size of the transformation angles ϑᵢ, the extension direction of the corresponding transformation edge relative to the first dimension direction p₁ and the second dimension direction p₂ can be adjusted.

In a more preferred scheme, when the transformation angle ϑᵢ is an acute angle, the range of the transformation angle ϑᵢ is more preferably set to be 40° to 90°. When the transformation angle ϑᵢ is an obtuse angle, the range of the transformation angle ϑᵢ is more preferably set to be 90° to 140°.

Further speaking, referring to FIG. 3A to FIG. 3H, the maximum ridge width of the first closed pattern 21 in the first dimension direction p₁ is l₁, and the maximum ridge width of the first closed pattern 21 in the second dimension direction p₂ is l₂. A reference parallelogram ABCD is set up by taking the maximum ridge width l₁ and the maximum ridge width l₂ as two groups of opposite edges. That is, the reference parallelogram ABCD is: the smallest parallelogram which can surround the first closed pattern 21 that is formed by taking the maximum ridge width l₁ and the maximum ridge width l₂ as two groups of opposite edges in the first dimension direction p₁ and the second dimension direction p₂ in which the micro-structure units 2 are periodically arranged at intervals.

In one or more embodiments, the transformation edges in the first closed pattern 21 include a first-type straight-line edge L₁ᵢ and/or a second-type straight-line edge L₂ᵢ and/or a third-type straight-line edge L₃ᵢ and/or a fourth-type straight-line edge Lai, and i=1, 2, 3, 4, . . . .

Referring to FIG. 3A to FIG. 3C, a first endpoint of the first-type straight-line edge L₁ᵢ is located on the vertex of the reference parallelogram ABCD, and a second endpoint of the first-type straight-line edge L₁ᵢ is located on one of the edges of the reference parallelogram ABCD. Taking FIG. 3B as an example: a first endpoint of a first-type straight-line edge L₁₁ is located on the vertex D of the reference parallelogram ABCD, and a second endpoint thereof is located on one edge BC of the reference parallelogram ABCD that is not adjacent to the vertex D; a first endpoint of another first-type straight-line edge L₁₃ is located on the vertex B of the reference parallelogram ABCD, and a second endpoint thereof is located on one edge AD of the reference parallelogram ABCD which is not adjacent to the vertex B. In some other possible embodiments, the second endpoint of the first-type straight-line edge L₁ᵢ is located on another vertex of the reference parallelogram ABCD, that is, the two endpoints of the first-type straight-line edge L₁ᵢ are located on different vertices of the reference parallelogram ABCD.

Further speaking, referring to FIG. 3A to FIG. 3C, the distance di between the second endpoint of the first-type straight-line edge L₁ᵢ located on one of the edges with an edge length of l₁₀ and the relatively closer endpoint of the one of the edges is

$$\frac{1}{10} {l}_{10} \leq {d}_{1 i} \leq \frac{1}{2} {l}_{10} ;$$

l₁₀ correspondingly takes the value of l₁ or l₂. Taking FIG. 3C as an example: the second endpoint of the first-type straight-line edge L₁₁ is located on the edge BC, the edge length of the edge BC is l₁, then l₁₀ correspondingly takes the value of l₁, and the distance d₁₁ between the second endpoint of the first-type straight-line edge L₁ᵢ and the relatively closer endpoint C of the edge BC is preferably

$$\frac{1}{10} {l}_{1} \leq {d}_{11} \leq \frac{1}{2} {l}_{1} .$$

The second endpoint of another first-type straight-line edge L₁₄ is located on one edge AB of the reference parallelogram ABCD, the edge length of the edge AB is l₂, then l₁₀ correspondingly takes the value of l₂, and the distance d₁₄ between the second endpoint of the first-type straight-line edge L₁₄ and the relatively closer endpoint A of the edge AB is preferably

$$\frac{1}{10} {l}_{2} \leq {d}_{14} \leq \frac{1}{2} {l}_{2} .$$

In a more preferable scheme, the distance d₁ᵢ is set to be

$$\frac{1}{4} {l}_{10} \leq {d}_{1 i} \leq \frac{1}{2} {l}_{10} .$$

It Shall be noted that, when the two endpoints of the first-type straight-line edge L₁ᵢ are located on different vertices of the reference parallelogram ABCD, d₁ᵢ=0.

Referring to FIG. 3D and FIG. 3E, first and second endpoints of the second-type straight-line edge L₂ᵢ are respectively located on two edges of the reference parallelogram ABCD in different directions. Taking FIG. 3D as an example: a first endpoint of the second-type straight-line edge L₂₁ is located on one edge BC of the reference parallelogram ABCD, and a second endpoint thereof is located on another edge CD of the reference parallelogram ABCD; a first endpoint of the second-type straight-line edge L₂₂ is located on one edge AD of the reference parallelogram ABCD, and a second endpoint thereof is located on another edge CD of the reference parallelogram ABCD.

Further speaking, referring to FIG. 3D and FIG. 3E, the distance d₂ᵢ between the first endpoint of the second-type straight-line edge L₂ᵢ located on one of the edges with an edge length of l₂₀ and the relatively closer endpoint of the one of the edges is preferably

$$\frac{1}{10} {l}_{20} \leq {d}_{2 i} \leq \frac{1}{2} {l}_{20} .$$

The distance d₃ᵢ between the second endpoint of the second-type straight-line edge L₂ᵢ located on another edge with an edge length of l₃₀ and the relatively closer endpoint of the another edge is preferably

$$\frac{1}{10} {l}_{30} \leq {d}_{3 i} \leq \frac{1}{2} {l}_{30} .$$

When l₂₀ correspondingly takes the value of l₁, l₃₀ correspondingly takes the value of l₂; and when l₂₀ correspondingly takes the value of l₂, l₃₀ correspondingly takes the value of l₁. Taking FIG. 3E as an example: the first endpoint of the second-type straight-line edge L₂₁ is located on the edge AD, the second endpoint thereof is located on another edge CD, the edge length of the edge AD is h, then 120 correspondingly takes the value of l₁, and the edge length of the edge CD is l₂, then l₃₀ correspondingly takes the value of l₂. At this point, the distance d₂₁ between the first endpoint of the second-type straight-line edge L₂₁ and the relatively closer endpoint D of the edge AD is preferably

$$\frac{1}{10} {l}_{1} \leq {d}_{21} \leq \frac{1}{2} {l}_{1} ,$$

and the distance d₃₁ between the second endpoint of the second-type straight-line edge L₂₁ and the relatively closer endpoint D of the edge CD is preferably

$$\frac{1}{10} {l}_{2} \leq {d}_{31} \leq \frac{1}{2} {l}_{2} .$$

It shall be noted that, the second endpoints of two second-type straight-line edges (L₂₁ and L₂₂) in FIG. 3D coincide, so the distances (d₃₁ and d₃₂) are the same, and in FIG. 3D, d₃₁ is marked. In a more preferred scheme, the distance d₂ᵢ is set to be

$$\frac{1}{4} {l}_{20} \leq {d}_{2 i} \leq \frac{1}{2} {l}_{20} ,$$

and the distance d₃ᵢ is set to be

$$\frac{1}{4} {l}_{30} \leq {d}_{3 i} \leq \frac{1}{2} {l}_{30} .$$

Referring to FIG. 3F to FIG. 3H, a first endpoint of the third-type straight-line edge L₃ᵢ is located on one of the edges or on the vertex of the reference parallelogram ABCD, and a second endpoint of the third-type straight-line edge L₃ᵢ is located inside the reference parallelogram ABCD. Taking FIG. 3F as an example: a first endpoint of the third-type straight-line edge L₃₁ is located on one edge CD of the reference parallelogram ABCD, and a second endpoint thereof is located inside the reference parallelogram ABCD; a first endpoint of the third-type straight-line edge L₃₂ is located on one edge CD of the reference parallelogram ABCD, and a second endpoint thereof is located inside the reference parallelogram ABCD.

Further speaking, referring to FIG. 3F and FIG. 3G, the distance d₄ᵢ between the first endpoint of the third-type straight-line edge L₃ᵢ located on one of the edges with an edge length of l₄₀ and the relatively closer endpoint of the one of the edges is

$$\frac{1}{10} {l}_{40} \leq {d}_{4 i} \leq \frac{1}{2} {l}_{40} ;$$

and l₄₀ correspondingly takes the value of l₁ or l₂. Taking FIG. 3F as an example: the first endpoint of the third-type straight-line edge L₃₁ is located on the edge CD, the edge length of the edge CD is l₂, then l₄₀ correspondingly takes the value of l₂, and the distance d₄₁ between the first endpoint of the third-type straight-line edge L₃₁ and the relatively closer endpoint C of the edge CD is preferably

$$\frac{1}{10} {l}_{2} \leq {d}_{41} \leq \frac{1}{2} {l}_{2} .$$

The first endpoint of the third-type straight-line edge L₃₂ is also located on the edge CD, and similarly, l₄₀ correspondingly takes the value of l₂, and the distance d₄₂ between the first endpoint of the third-type straight-line edge L₃₂ and the relatively closer endpoint D of the edge CD is preferably

$$\frac{1}{10} {l}_{2} \leq {d}_{42} \leq \frac{1}{2} {l}_{2} .$$

In a more preferred scheme, the distance d₄ᵢ is set to be

$$\frac{1}{4} {l}_{40} \leq {d}_{4 i} \leq \frac{1}{2} {l}_{40} .$$

It shall be noted that, when there are two said third-type straight-line edges L₃ᵢ, and the first endpoints of the two third-type straight-line edges L₃ᵢ are located on the same edge, the corresponding distance d₄ᵢ of the two third-type straight-line edges L₃ᵢ cannot be half the length of the corresponding edge at the same time. When the first endpoint of the third-type straight-line edge L₃ᵢ is located on the vertex of the reference parallelogram ABCD, d₄ᵢ=0.

In some embodiments, referring to FIG. 3A to FIG. 3F, the transformation angle ϑᵢ is an acute angle. In some other embodiments, referring to FIG. 3G, the transformation angle ϑ₂ is an acute angle and the transformation angle ϑ₁ is an obtuse angle.

Referring to FIG. 3H, both the first endpoint and the second endpoint of the fourth-type straight-line edge L₄ᵢ are located inside the reference parallelogram ABCD, such as the fourth-type straight-line edge L₄₁ in FIG. 3H.

In the structure shown in FIG. 3A to FIG. 3H, the transformation edges in the first closed pattern 21 shown in FIG. 3A to FIG. 3C include the first-type straight-line edge L₁ᵢ; the transformation edges in the first closed pattern 21 shown in FIG. 3D and FIG. 3E include the second-type straight-line edge L₂ᵢ; the transformation edges in the first closed pattern 21 shown in FIG. 3F and FIG. 3G include the third-type straight-line edge L₃ᵢ, and the transformation edge in the first closed pattern 21 shown in FIG. 3H includes the third-type straight-line edge L₃ᵢ and the fourth-type straight-line edge L₄ᵢ.

Based on the above structural pattern, some shape changes that are easy to be contemplated are as follows: for example, if the edge AB in FIG. 3D is set to be the first-type straight-line edge L₁₃ in the structure of FIG. 3B, then the transformation edges in the first closed pattern 21 include the first-type straight-line edge L₁ᵢ and the second-type straight-line edge L₂ᵢ. For example, if the edge AB in FIG. 3F is set to be the first-type straight-line edge L₁₃ in the structure of FIG. 3B, then the transformation edges in the first closed pattern 21 include the first-type straight-line edge L₁ᵢ and the third-type straight-line edge L₃ᵢ. For example, if the edge AB in FIG. 3H is set to be the first-type straight-line edge L₁₃ in the structure of FIG. 3B, then the transformation edges in the first closed pattern 21 includes the first-type straight-line edge L₁ᵢ, the third-type straight-line edge L₃ᵢ and the fourth-type straight-line edge L₄ᵢ.

In one or more embodiments, referring to FIG. 3H, the transformation edges in the first closed pattern 21 include two said third-type straight-line edges L₃₁ and L₃₂, and two second endpoints of the two third-type straight-line edges L₃₁ and L₃₂ located inside the reference parallelogram ABCD are connected with each other by one said fourth-type straight-line edge L₄₁. In some other embodiments, two second endpoints of the two third-type straight-line edges L₃₁ and L₃₂ may also be connected with each other through more fourth-type transformation edges Lai, and/or curved-line edges and/or straight-line edges parallel to the first dimension direction p₁ or the second dimension direction p₂.

Referring to FIG. 3A to FIG. 3H, in the diffraction grating provided according to the embodiments of the present disclosure, adjustable parameters of the micro-structure unit 2 include: (1) the duty ratio l₁/|p₁| and l₂/|p₂| of the micro-structure unit 2 in the two dimension directions periodically arranged; (2) the number of edges that are neither parallel to the first dimension direction p₁ nor to the second dimension direction p₂; (3) the size of the transformation angle ϑᵢ for the transformation edge; (4) the position of the transformation edge (the position of the two endpoints); (5) the combination of different types of transformation edges and curved-line edges. As can be seen, the micro-structure unit 2 has more adjustable parameters and rich degree of freedom for design.

In a further preferred scheme, taking the micro-structure unit 2 shown in FIG. 3C as an example, when there are two or more said transformation edges, the transformation angles ϑᵢ corresponding to the two or more transformation edges are not equal to each other.

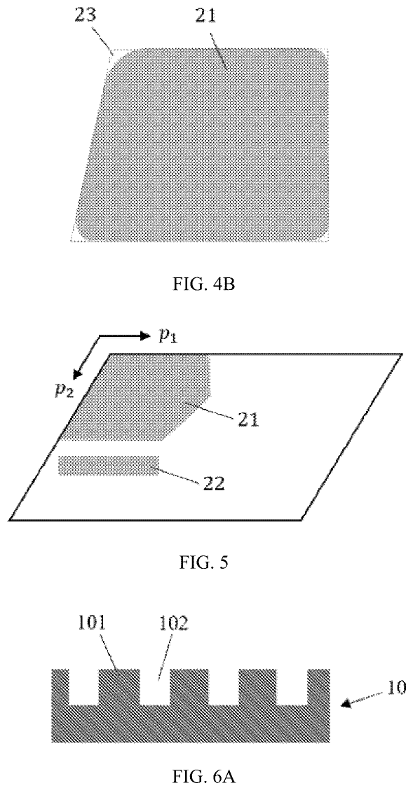

In the preferred scheme, referring to FIG. 4A and FIG. 4B, the first closed pattern 21 has a vertex 23, and the vertex 23 is formed into a straight chamfer (as shown in FIG. 4A) or a circular chamfer (as shown in FIG. 4B). By providing the straight chamfer or the circular chamfer, the number of small inner angles to be machined in the micro-structure can be reduced, which can reduce the processing difficulty, improve the yield, reduce the scattering and improve the image contrast of the process. The chamfering edge length of the straight chamfer is less than half of the length of the shortest straight-line edge among the three or more edges, and it usually ranges from 1 nm to 500 nm. The radius of curvature of the circular chamfer is less than half of the length of the shortest straight-line edge among the three or more edges, and it usually ranges from 1 nm to 500 nm.

FIG. 5 shows the structural shape of the micro-structure unit 2 in some other specific embodiments of the present disclosure. In some other specific embodiments, the pattern formed by the orthographic projection of the micro-structure unit 2 on the substrate 1 may further include a second closed pattern 22 in addition to the first closed pattern 21 as described above. The boundary of the second closed pattern 22 may be a pattern of any shape, and may be a pattern enclosed by one or more straight-line segments and/or one or more curved-line segments. For example, the pattern may be circular, elliptical, fan-shaped, annular or polygonal. Generally, the area of the second closed pattern 22 is smaller than that of the first closed pattern 21. As shown in FIG. 5, the second closed pattern 22 is rectangular.

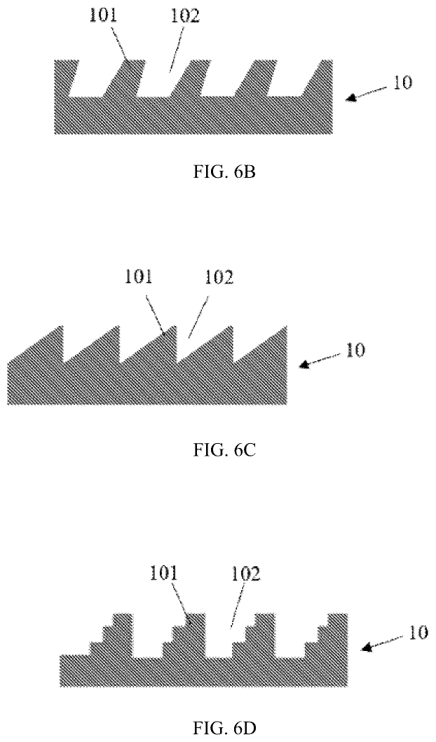

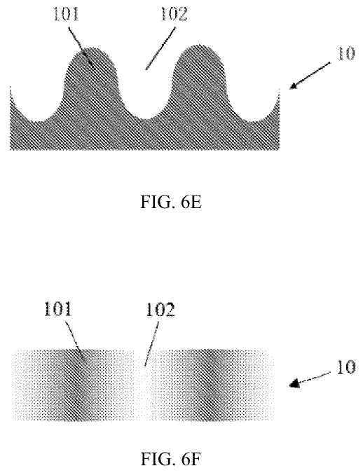

In the embodiment of the present disclosure, the diffraction grating 10 as described above may be realized in the form of a surface relief grating or a volume holographic grating. Specifically, the thickness of the grating is between 10 nm and 2 μm. FIG. 6A to FIG. 6F show cross-sectional views of diffraction gratings in some specific embodiments of the present disclosure. FIG. 6A is the structural diagram of a relief grating with straight groove envelope, FIG. 6B is the structural diagram of a relief grating with slanted tooth envelope, FIG. 6C is the structural diagram of a relief grating with blazed envelope, FIG. 6D is the structural diagram of a relief grating with step envelope, FIG. 6E is the structural diagram of a relief grating with curved-surface envelope, and FIG. 6F is the structural diagram of a volume holographic grating.

In the embodiment of the present disclosure, the diffraction grating 10 is composed of at least two optical materials with different optical characteristics, including refractive index, and/or absorption characteristics and/or birefringence characteristics. Therefore, if the grating is in air, then air is also considered as an optical material. For materials without birefringence, the optical characteristics of the materials can be comprehensively described by refractive index and absorption characteristics. When the difference between the two optical materials mainly lies in the refractive index, the grating may be divided into a high refractive-index portion and a low refractive-index portion. Referring to FIG. 6A to FIG. 6F, the diffraction grating 10 includes a high refractive-index portion 101 and a low refractive-index portion 102. It is worth noting that, the diagram may also be used to distinguish two optical materials with different absorption characteristics and/or different birefringence characteristics.

For the surface relief grating, the area of the micro-structure unit 2 is preferably formed at half the grating thickness, and in some specific schemes, the area of the micro-structure unit 2 in the diffraction grating 10 is provided as the high refractive-index portion, and other areas surrounding the area of the micro-structure unit 2 are disposed as the low refractive-index portions 102. The refractive index of the high refractive-index portion 101 is between 1.5 and 3.0, and the refractive index of the low refractive-index portion 102 is between 1.0 and 1.5. In some other specific schemes, the area of the micro-structure unit 2 in the diffraction grating 10 is provided as the low refractive index portion 102, and other areas surrounding the area of the micro-structure unit 2 are provided as the high refractive-index portions 101.

For a volume holographic grating with refractive index gradient, the area of the micro-structure unit 2 preferably corresponds to half the thickness of the grating. Taking the contour corresponding to the average refractive index of the optical materials as the boundary, the portion with a refractive index greater than the average refractive index is defined as a the high refractive-index portion, and the part with a refractive index less than the average refractive index is defined as the low refractive-index portion. The area of the micro-structure unit 2 is a portion surrounded by the contour corresponding to the average refractive index of the optical materials, and it may be provided as the high refractive-index portion or the low refractive-index portion.

Based on the diffraction grating provided in the above embodiments, an embodiment of the present disclosure further provides an optical waveguide apparatus, which includes a base, and a coupling-in grating and a coupling-out grating arranged on the base, in which the coupling-in grating is configured to couple an external light beam into the base, and the coupling-out grating is configured to couple the light beam out of the base. In a further embodiment, the optical waveguide apparatus may further include an intermediate grating. The diffraction grating provided according to the embodiment of the present disclosure is used in part or all areas of the coupling-in grating and/or the coupling-out grating and/or the intermediate grating. It shall be noted that when the diffraction grating provided according to the embodiment of the present disclosure is applied to an optical waveguide apparatus, the base of the optical waveguide apparatus can be directly reused as the substrate of the diffraction grating, that is, the base of the optical waveguide apparatus and the substrate of the diffraction grating are integrated.

In an optional scheme, in the optical waveguide apparatus, there are one or more layers of coating on the side of the diffraction grating close to and/or far from the human eyes, and there are one or more layers of coating on the grating-free side of the base. Further speaking, the base may be a multilayer structure, and the diffraction grating may be a multilayer structure.

Further speaking, the present disclosure further provides a display device, such as an augmented reality (AR) display device or a mixed reality (MR) display device. The display device includes a projection device and the optical waveguide apparatus provided in the above embodiment of the present disclosure. The projection device is configured to generate image light (light carrying image information), and the image light is coupled into the base by the coupling-in grating, transmitted to the coupling-out grating via the base, and then coupled out of the base by the coupling-out grating, and transmitted to human eyes, so that the human eyes can observe the corresponding image information.

According to the above description, for the diffraction grating, the optical waveguide apparatus and the display device provided according to the above embodiments of the present disclosure, the micro-structure unit of the two-dimensional diffraction grating is an asymmetric structure, and among the edges constituting the boundary of the micro-structure unit of the two-dimensional diffraction grating, there is at least one straight-line edge which is not parallel to either of the two dimension directions periodically arranged. Consequently, the micro-structure unit has more adjustable parameters and rich degree of freedom for design, therefore facilitating the adjustment of coupling-out efficiency, and improving diffraction selectivity, diffraction efficiency and brightness of images watched by human eyes.

Although the present disclosure has been shown and described with reference to specific embodiments, it shall be understood by those skilled in the art that various changes in forms and details may be made herein without departing from the spirit and scope of the present disclosure as defined by the claims and equivalents thereof.

What is claimed is:

1. A diffraction grating, comprising:
a substrate;
a plurality of micro-structure units formed on the substrate and periodically arranged at intervals in a first dimension direction and a second dimension direction, a pattern formed by the orthographic projections of the micro-structure units on the substrate comprises a first closed pattern, wherein
the first closed pattern is an asymmetric pattern, the boundary of the first closed pattern is formed by sequentially connecting three or more edges in a surrounding manner, and among the three or more edges, there is at least one straight-line edge, which is neither parallel to the first dimension direction nor to the second dimension direction.

2. The diffraction grating according to claim 1, wherein the straight-line edge neither parallel to the first dimension direction nor to the second dimension direction is a transformation edge, an included angle formed by the intersection of the transformation edge with the first dimension direction or the second dimension direction and located outside the first closed pattern is a transformation angle ϑᵢ, and the transformation angle ϑᵢ ranges from 5° to 175°.

3. The diffraction grating according to claim 2, wherein the transformation edge in the first closed pattern includes one or more of a first-type straight-line edge, a second-type straight-line edge, a third-type straight-line edge or a fourth-type straight-line edge; wherein
a reference parallelogram is set up by taking the maximum ridge width l₁ of the first closed pattern in the first dimension direction and the maximum ridge width l₂ of the first closed pattern in the second dimension direction as two groups of opposite edges;
a first endpoint of the first-type straight-line edge is located on a first vertex of the reference parallelogram, a second endpoint of the first-type straight-line edge is located on a first edge of the reference parallelogram or on a second vertex of the reference parallelogram, where the first edge is an edge of the reference parallelogram that is not adjacent to the first vertex, the first vertex and the second vertex are both vertices of the reference parallelogram, the first vertex and the second vertex are different;
a first endpoint of the second-type straight-line edge is located on a second edge of the reference parallelogram, a second endpoint of the second-type straight-line edge is located on a third edge of the reference parallelogram, where the second edge is any one of edges of the reference parallelogram, and a direction of the third edge is different from a direction of the second edge;
a first endpoint of the third-type straight-line edge is located on a fourth edge of the reference parallelogramor on a third vertex of the reference parallelogram, and a second endpoint of the third-type straight-line edge is located inside the reference parallelogram, where the third vertex is a vertex of the reference parallelogram and the fourth edge is any one of edges of the reference parallelogram; and
a first endpoint and a second endpoint of the fourth-type straight-line edge are both located inside the reference parallelogram;
the first edge is same as or different from the second edge, the third edge, or the fourth edge; the fourth edge is same as or different from the second edge or the third edge; the third vertex is same as or different from the first vertex or the second vertex.

4. The diffraction grating according to claim 3, wherein an edge length of the first edge is l₁₀, a distance between the second endpoint of the first-type straight-line edge and an endpoint of the first edge near the second endpoint of the first-type straight-line edge is d₁ᵢ,
$$\frac{1}{10} {l}_{10} \leq {d}_{1 i} \leq \frac{1}{2} {l}_{10} ,$$
l₁₀ correspondingly takes the value of l₁ or l₂;
an edge length of the second edge is l₂₀, a distance between the first endpoint of the second-type straight-line edge and an endpoint of the second edge near the first endpoint of the second-type straight-line edge is d₂ᵢ,
$$\frac{1}{10} {l}_{20} \leq {d}_{2 i} \leq \frac{1}{2} {l}_{20} ;$$
an edge length of the third edge is l₃₀, a distance between the second endpoint of the second-type straight-line edge and an endpoint of the third edge near the second endpoint of the second-type straight-line edge is d₃ᵢ,
$$\frac{1}{10} {l}_{30} \leq {d}_{3 i} \leq \frac{1}{2} {l}_{30} ,$$
l₃₀ correspondingly takes the value of l₂ when l₂₀ correspondingly takes the value of l₁, and l₃₀ correspondingly takes the value of l₁ when l₂₀ correspondingly takes the value of l₂;
an edge length of the fourth edge is l₄₀, a distance between the first endpoint of the third-type straight-line edge and an endpoint of the fourth edge near the first endpoint of the third-type straight-line edge is d₄ᵢ,
$$\frac{1}{10} {l}_{40} \leq {d}_{4 i} \leq \frac{1}{2} {l}_{40} ,$$
and l₄₀ correspondingly takes the value of l₁ or l₂.

5. The diffraction grating according to claim 3, wherein the transformation edge in the first closed pattern includes two said third-type straight-line edges, and two second endpoints of the two third-type straight-line edges located inside the reference parallelogram are connected with each other by one or more of following edges:
one or more the fourth-type straight-line edges;
one or more curved-line edges;
one or more straight-line edges parallel to the first dimension direction or the second dimension direction.

6. The diffraction grating according to claim 2, wherein among the three or more edges, there are at least two or more said transformation edges, and the two or more transformation edges correspond to transformation angles which are not equal to each other.

7. The diffraction grating according to claim 1, wherein the first closed pattern has at least one curved-line edge.

8. The diffraction grating according to claim 1, wherein the pattern formed by the orthographic projections of the micro-structure units on the substrate further includes a second closed pattern of an arbitrary shape.

9. The diffraction grating according to claim 1, wherein in the first dimension direction and the second dimension direction in which the micro-structure units are periodically arranged, in a parallelogram formed by taking two arrangement periods as two groups of opposite edges, the angle of the relatively smaller inner angle is 30° to 85°.

10. The diffraction grating according to claim 1, wherein both the arrangement period of the micro-structure units in the first dimension direction and the arrangement period of the micro-structure units in the second dimension direction range from 150 nm to 2 μm.

11. The diffraction grating according to claim 10, wherein the arrangement period of the micro-structure units in the first dimension direction and the arrangement period of the micro-structure units in the second dimension direction are not equal.

12. The diffraction grating according to claim 1, wherein the diffraction grating is a surface relief grating or a volume holographic grating, and the thickness of the diffraction grating ranges from 10 nm to 2 μm.

13. The diffraction grating according to claim 12, wherein the diffraction grating comprises at least two optical material components with different optical characteristics, and the optical characteristics include at least one of refractive index, absorption characteristics and birefringence characteristics.

14. The diffraction grating according to claim 13, wherein for the surface relief grating, the micro-structure unit area is formed at half the grating thickness, the micro-structure unit area in the diffraction grating is provided as a high refractive-index portion, and other areas surrounding the micro-structure unit area are provided as low refractive-index portions; or
the micro-structure unit area in the diffraction grating is provided as a low refractive-index portion, and other areas surrounding the micro-structure unit area are provided as high refractive-index portions;
for a volume holographic grating with a refractive index gradient, the micro-structure unit area corresponds to half of the grating thickness, and the micro-structure unit area is the portion surrounded by the contour corresponding to the average refractive index of optical materials.

15. An optical waveguide apparatus, comprising:
a base;
the base being provided with one or more of a coupling-in grating, a coupling-out grating or an intermediate grating; wherein
one or more of the coupling-in grating, the coupling-out grating or the intermediate grating adopts a diffraction grating in some areas, wherein the diffraction grating comprises:
a substrate;
a plurality of micro-structure units formed on the substrate and periodically arranged at intervals in a first dimension direction and a second dimension direction, a pattern formed by the orthographic projections of the micro-structure units on the substrate comprises a first closed pattern, wherein
the first closed pattern is an asymmetric pattern, the boundary of the first closed pattern is formed by sequentially connecting three or more edges in a surrounding manner, and among the three or more edges, there is at least one straight-line edge, which is neither parallel to the first dimension direction nor to the second dimension direction.

16. The optical waveguide apparatus according to claim 15, wherein there are one or more layers of coating on the side of the diffraction grating close to or far from the human eyes, and there are one or more layers of coating on the grating-free side of the base.

17. The optical waveguide apparatus according to claim 15, wherein the straight-line edge neither parallel to the first dimension direction nor to the second dimension direction is a transformation edge, an included angle formed by the intersection of the transformation edge with the first dimension direction or the second dimension direction and located outside the first closed pattern is a transformation angle ϑᵢ, and the transformation angle ϑᵢ ranges from 5° to 175°.

18. The optical waveguide apparatus according to claim 17, wherein the transformation edge in the first closed pattern includes one or more of a first-type straight-line edge, a second-type straight-line edge, a third-type straight-line edge or a fourth-type straight-line edge; wherein
a reference parallelogram is set up by taking the maximum ridge width l₁ of the first closed pattern in the first dimension direction and the maximum ridge width l₂ of the first closed pattern in the second dimension direction as two groups of opposite edges;
a first endpoint of the first-type straight-line edge is located on a first vertex of the reference parallelogram, a second endpoint of the first-type straight-line edge is located on a first edge of the reference parallelogram or on a second vertex of the reference parallelogram, where the first edge is an edge of the reference parallelogram that is not adjacent to the first vertex, the first vertex and the second vertex are both vertices of the reference parallelogram, the first vertex and the second vertex are different;
a first endpoint of the second-type straight-line edge is located on a second edge of the reference parallelogram, a second endpoint of the second-type straight-line edge is located on a third edge of the reference parallelogram, where the second edge is any one of edges of the reference parallelogram, and a direction of the third edge is different from a direction of the second edge;
a first endpoint of the third-type straight-line edge is located on a fourth edge of the reference parallelogram or on a third vertex of the reference parallelogram, and a second endpoint of the third-type straight-line edge is located inside the reference parallelogram, where the third vertex is a vertex of the reference parallelogram and the fourth edge is any one of edges of the reference parallelogram; and
a first endpoint and a second endpoint of the fourth-type straight-line edge are both located inside the reference parallelogram;
the first edge is same as or different from the second edge, the third edge, or the fourth edge; the fourth edge is same as or different from the second edge or the third edge; the third vertex is same as or different from the first vertex or the second vertex.

19. The optical waveguide apparatus according to claim 18, wherein an edge length of the first edge is l₁₀, a distance between the second endpoint of the first-type straight-line edge and an endpoint of the first edge near the second endpoint of the first-type straight-line edge is d₁ᵢ,
$$\frac{1}{10} {l}_{10} \leq {d}_{1 i} \leq \frac{1}{2} {l}_{10} ,$$
l₁₀ correspondingly takes the value of l₁ or l₂;
an edge length of the second edge is l₂₀, a distance between the first endpoint of the second-type straight-line edge and an endpoint of the second edge near the first endpoint of the second-type straight-line edge is d₂ᵢ,
$$\frac{1}{10} {l}_{20} \leq {d}_{2 i} \leq \frac{1}{2} {l}_{20} ;$$
an edge length of the third edge is l₃₀, a distance between the second endpoint of the second-type straight-line edge and an endpoint of the third edge near the second endpoint of the second-type straight-line edge is d₃ᵢ,
$$\frac{1}{10} {l}_{30} \leq {d}_{3 i} \leq \frac{1}{2} {l}_{30} ,$$
l₃₀ correspondingly takes the value of l₂ when l₂₀ correspondingly takes the value of l₁, and l₃₀ correspondingly takes the value of l₁ when l₂₀ correspondingly takes the value of l₂;
an edge length of the fourth edge is l₄₀, a distance between the first endpoint of the third-type straight-line edge and an endpoint of the fourth edge near the first endpoint of the third-type straight-line edge is d₄ᵢ,
$$\frac{1}{10} {l}_{40} \leq {d}_{4 i} \leq \frac{1}{2} {l}_{40} ,$$
and l₄₀ correspondingly takes the value of l₁ or l₂.

20. A display device, comprising an optical waveguide apparatus, wherein the optical waveguide apparatus comprises:
a base;
the base being provided with one or more of a coupling-in grating, a coupling-out grating or an intermediate grating; wherein
one or more of the coupling-in grating, the coupling-out grating or the intermediate grating adopts a diffraction grating, wherein the diffraction grating comprises:
a substrate;
a plurality of micro-structure units formed on the substrate and periodically arranged at intervals in a first dimension direction and a second dimension direction, a pattern formed by the orthographic projections of the micro-structure units on the substrate comprises a first closed pattern, wherein
the first closed pattern is an asymmetric pattern, the boundary of the first closed pattern is formed by sequentially connecting three or more edges in a surrounding manner, and among the three or more edges, there is at least one straight-line edge, which is neither parallel to the first dimension direction nor to the second dimension direction.
